(19) United States
(12) Patent Application Publication
(10) Pub. No.: US 2012/0316205 A1
(43) Pub. Date: Dec. 13, 2012

(54) OIL DISPERSION OF SULFOXIMINES FOR THE CONTROL OF INSECTS

(75) Inventors: Kuide Qin, Westfield, IN (US); James D. Thomas, Fishers, IN (US); Fikru Haile, Carmel, IN (US); Doris Paroonagian, Walnut Creek, CA (US)

(73) Assignee: DOW AGROSCIENCES LLC, Indianapolis, IN (US)

(21) Appl. No.: 13/489,053

(22) Filed: Jun. 5, 2012

Related U.S. Application Data
(60) Provisional application No. 61/494,178, filed on Jun. 7, 2011.

(51) Int. Cl. A01N 43/40; A01P 7/02; A01P 13/00; A01P 7/04; A01P 3/00

(52) U.S. Cl. 514/357

(57) ABSTRACT

The invention relates to oil dispersions of sulfoximine insecticides, such as sulfoxaflor, and methods of using these dispersions to control insects such as whitefly.

### CROSS-REFERENCE TO RELATED APPLICATION

This application claims the benefit of U.S. Provisional Patent Application Ser. No. 61/494,178, filed Jun. 7, 2011, the disclosure of which is hereby incorporated herein in its entirety by this reference.

### FIELD OF THE INVENTION

This invention relates generally to formulation of the active ingredient [methyl(oxo){1-[6-trifluoromethyl)-3-pyridyl]ethyl}-λ⁶-sulfanylidene]cyanamide and similar compounds dispersed in water-immiscible solvents.

### BACKGROUND

Sulfoximines with insecticidal activity have widespread utility for the control of insect. One particularly useful sulfoximine in this regard is a compound called sulfoxaflor, which is its common name, [methyl(oxo){1-[6-trifluoromethyl)-3-pyridyl]ethyl}-λ⁶-sulfanylidene]cyanamide, which is its IUPAC name, and N-[methyloxido[1-[6-(trifluoromethyl)-3-pyridinyl]ethyl]-λ⁴-sulfanylidene]cyanamide, which is its CAS Name. It has the following structure.

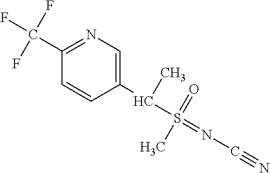

Despite the utility of sulfoximines, the ability of these compounds to efficiently control insect varies with a large number of parameters including, but not limited to, the species of insect to be controlled, the types of plant to be protected and the ambient conditions, such as temperature, humidity, hydration, length of day, biological diversity of the micro environment, and the like. Accordingly, there is a need for formulations of sulfoximines that extend the utility and/or increase the efficacy of these compounds. One object of the invention is to address this need.

### SUMMARY

Some aspects of the invention include sulfoximines with insecticidal activity, such as sulfoxaflor, formulated into oil dispersion using water-immiscible solvents for the control of insects. Insects that can be controlled using these formulations include, but are not limited to, sucking insects such as aphids. In some embodiments, the formulation may further include one or more of the following compounds: emulsifiers, coolants, dispersants, thickening agents, bactericides, bacteriostats, antioxidants, ultra violet light absorbing molecules, and other agriculturally active ingredients such as other insecticides, miticides, fungicides, herbicides, and the like.

Still other aspects of the invention include methods of controlling insect infestations by applying formulations that include sulfoximines, such as [methyl(oxo){1-[6-trifluoromethyl)-3-pyridyl]ethyl}-λ⁶-sulfanylidene]cyanamide, formulated into oil dispersion using water-immiscible solvents by applying these formulations to areas adjacent to or susceptible to insect infestation.

### DESCRIPTION

For the purposes of describing the principles of the novel technology, reference will now be made to the particular embodiments thereof, and specific language will be used to describe the same. It will, nevertheless, be understood that no limitation of the scope of the novel technology is thereby intended, such alterations, modifications, and further applications of the principles of the novel technology being contemplated as would normally occur to one skilled in the art to which the novel technology relates.

Pests, such as whiteflies of the genus Bemisia, are responsible for crop damage in many parts of world. Particularly damaging species include B. tabaci and B. argenifolii. Whiteflies infect a wide variety of very important crop plants, such as beans, tomatoes, cassava, cotton, potatoes, and sweet potatoes. Historically, these insects have been especially problematic in the tropical and subtropical regions. These insects feed by inserting their mouthparts into the phloem of the plant and sucking water and nutrients from the plant, thereby depriving the plant of nutrients and reducing its turgor. Additionally, the wounds that they create in the plants from which they feed provide an avenue for viral infection. In fact, many very harmful plant viruses may have evolved an ability to exist in whitefly secretions as their presence there provides them with ready access to plants that they are able to infect.

Whiteflies, like many insects that infest crop plants, have demonstrated a remarkable ability to evolve resistance to frequently used insecticides. Accordingly, the introduction of sulfoximines, such as sulfoxaflor, with insecticidal activity towards these types of insects is a welcome addition to the ranks of compounds that can be used to treat infestations of these and other susceptible insects. For additional information on these insecticides, see, for example, U.S. Pat. No. 7,687,634 issued on Mar. 30, 2010, which is incorporated herein by reference in its entirety.

In order to minimize the amount of insecticide that needs to be applied to a given area to control, rollback, contain, or prevent an infestation of damaging insects and thereby reduce the cost of using the insecticide, it may be useful to formulate the insecticide in a formulation that increases its ability to control the target insect. Additional design considerations that go into providing an insecticidal formulation with increased utility include its stability both in storage and after application, ease of dispersion, and rate of insect control.

Given the vast array of additives that can be combined with an insecticide to produce formulations of a new insecticide that has advantageous properties, the development of these formulations may require extensive, expensive and commercially risky investment in time and resources. Additionally, the complex interplay between agriculturally active ingredients, other components in a given formulation as well the interplay between the various plant species and the insects that attack those plants make success in this field unlikely. Aspects of the invention disclosed herein include formulation of compounds, such as Sulfoxaflor, and water-immiscible components to create an Oil Dispersion (OD) of Sulfoxaflor in a suitable carrier.

Sulfoximines for use with the present invention can be utilized in sufficient amounts to provide insecticidal activity. According to a particular embodiment of the invention, about 10% to about 50% by weight of the total insecticidal formulation of sulfoximine can be used at any specific amount within the stated range. In another embodiment of the invention, about 12% to about 48% by weight of sulfoximine can be used at any specific amount within the stated range. In yet another embodiment, about 20% to about 40% of sulfoximine can be used at any specific amount within the stated range.

Various non-water-miscible solvents that can be used in these formulations include, but are not limited to, one or more petroleum distillates, such as: aromatic hydrocarbons derived from benzene, such as toluene, xylenes, other alkylated benzenes and the like, and naphthalene derivatives, aliphatic hydrocarbons such as hexane, octane, cyclohexane, and the like, mineral oils from the aliphatic or isoparaffinic series, and mixtures of aromatic and aliphatic hydrocarbons; halogenated aromatic or aliphatic hydrocarbons; vegetable, seed or animal oils such as soybean oil, rape seed oil, olive oil, castor oil, sunflower seed oil, coconut oil, corn oil, cotton seed oil, linseed oil, palm oil, peanut oil, safflower oil, sesame oil, tung oil and the like, and C₁-C₆ mono-esters derived from vegetable, seed or animal oils; C₁-C₆ dialkyl amides of C₆-C₂₀ saturated and unsaturated aliphatic carboxylic acids, such as, N—N-dimethyl alkyl amide; C₁-C₁₂ esters of aromatic carboxylic acids and dicarboxylic acids and C₁-C₁₂ esters of aliphatic and cyclo-aliphatic carboxylic acids; C₄-C₁₂ polyesters of dihydric, trihydric, or other lower polyalcohols such as, propylene glycol dioleate, di-octyl succinate, di-butyl adipate, di-octyl phthalate and the like.

These formulations may also include other additives as may be added to such compositions to increase their stability such as bactericides and bacteriostats. Still other additives that may be added to the foundation include dyes, thickening agents, emulsifiers, defoamers, wetting agents, dispersants, and in some instance other agriculturally active ingredients including, for example, other insecticides, or herbicides, miticides, fungicides and the like.

The formulations may include an emulsifier in an amount from about 1% to about 30% by weight. Suitable emulsifiers include, but are not limited to, lecithin and modified lecithins, mono- and diglycerides, sorbitan monopalmitate, sorbitan monooleate, sorbitan monolaurate, polyoxyethylene-sorbitan monooleate, fatty acids, lipids, etc. The emulsifiers added to a formulation may provide or improve the emulsification properties of the composition. Emulsifiers can be used and may be selected from many products which are well known in the art including, but not limited to, sorbitan monolaurate (anhydrosorbitol stearate, molecular formula C₂₄H₄₆O₆), ARLACEL 60, ARMOTAN MS, CRILL 3, CRILL K3, DREWSORB 60, DURTAN 60, EMSORB 2505, GLYCOMUL S, HODAG SMS, IONET S 60, LIPOSORB S, LIPOSORB S-20, MONTANE 60, MS 33, MS33F, NEWCOL 60, NIKKOL SS 30, NISSAN NONION SP 60, NONION SP 60, NONION SP 60R, RIKEMAL S 250, sorbitan c, sorbitan stearate, SORBON 60, SORGEN 50, SPAN 55, AND SPAN 60. Still other sorbitan fatty acid ester that may be used in these formulations include, for example, sorbitan monopalmitate, sorbitan monostearate, sorbitan tristearate, sorbitan monooleate, sorbitan sesquioleate, sorbitan trioleate, sorbitan monooleate, sorbitan trioleate.

A variety of additives may be included in the formulations. These additives typically change and/or enhance the physical characteristics of the carrier material and are, therefore, suitable for designing compositions having specific requirements such as release rates, the amount of semiochemicals/attractants and/or repellents released, protection of the wax composition from various weather conditions, etc. These additional additives include, among others, plasticizers, volatility suppressants, antioxidants, lipids, various ultraviolet blockers and absorbers, or antimicrobials, typically added in amounts from about 0.001% to about 10%, more typically between 0.1-5%, by weight.

Plasticizers, such as glycerin or soy oil that affect the physical properties of the composition and may extend its resistance to environmental destruction may also be added.

Antioxidants, such as vitamin E, BHA (butylated hydroxyanisole), BHT (butylated hydroxytoluene), and other antioxidants which protect the bioactive agent from degradation, may be added to the formulation in amounts from about 0.1% to about 3%, by weight.

Ultraviolet blockers, such as beta-carotene or p-aminobenzoic acid that protect the bioactive agents from light degradation may be added to the formulation in amounts ranging from about 1% to about 3%, by weight.

Antimicrobials, such as potassium sorbate, nitrates, nitrites, and propylene oxide, which protect the bioactive agents from microbial destruction, may be also added to the formulation in amounts ranging from 0.1% to about 2% by weight.

The formulations of the present invention may be applied in conjunction with one or more other agriculturally active ingredients, such as other insecticides, fungicides, or herbicides to obtain control over a wider variety of insects, diseases and weeds. When used in conjunction with other agriculturally active ingredients, the presently claimed compounds can be formulated with the other insecticides, or fungicides, or herbicides, tank mixed with the other insecticides or fungicides or herbicides, or applied sequentially with the other insecticides or fungicides or herbicides.

Some of the insecticides that can be employed beneficially in combination with the formulations of the present invention include: antibiotic insecticides, such as allosamidin and thuringiensin; macrocyclic lactone insecticides, such as spinosad, spinetoram, and other spinosyns including the 21-butenyl spinosyns and their derivatives; avermectin insecticides, such as abamectin, doramectin, emamectin, eprinomectin, ivermectin and selamectin; milbemycin insecticides, such as lepimectin, milbemectin, milbemycin oxime and moxidectin; arsenical insecticides, such as calcium arsenate, copper acetoarsenite, copper arsenate, lead arsenate, potassium arsenite and sodium arsenite; biological insecticides such as Bacillus popilliae, B. sphaericus, B. thuringiensis subsp. aizawai, B. thuringiensis subsp. kurstaki, B. thuringiensis subsp. tenebrionis, Beauveria bassiana, Cydia pomonella granulosis virus, Douglas fir tussock moth NPV, gypsy moth NPV, Helicoverpa zea NPV, Indian meal moth granulosis virus, Metarhizium anisopliae, Nosema locustae, Paecilomyces fumosoroseus, P. lilacinus, Photorhabdus luminescens, Spodoptera exigua NPV, trypsin modulating oostatic factor, Xenorhabdus nematophilus, and X bovienii, plant incorporated protectant insecticides such as Cry1Ab, Cry1Ac, Cry1F, Cry1A.105, Cry2Ab2, Cry3A, mir Cry3A, Cry3Bb1, Cry34, Cry35, and VIP3A; botanical insecticides, such as anabasine, azadirachtin, d-limonene, nicotine, pyrethrins, cinerins, cinerin I, cinerin II, jasmolin I, jasmolin II, pyrethrin I, pyrethrin II, quassia, rotenone, ryania and sabadilla; carbamate insecticides such as bendiocarb and carbaryl; benzofuranyl methylcarbamate insecticides, such as benfuracarb, carbofuran, carbosulfan, decarbofuran and furathiocarb; dimethylcarbamate insecticides dimitan, dimetilan, hyquincarb and pirimicarb; oxime carbamate insecticides, such as alanycarb, aldicarb, aldoxycarb, butocarboxim, butoxycarboxim, methomyl, nitrilacarb, oxamyl, tazimcarb, thiocarboxime, thiodicarb and thiofanox; phenyl methylcarbamate insecticides, such as allyxycarb, aminocarb, bufencarb, butacarb, carbanolate, cloethocarb, dicresyl, dioxacarb, EMPC, ethiofencarb, fenethacarb, fenobucarb, isoprocarb, methiocarb, metolcarb, mexacarbate, promacyl, promecarb, propoxur, trimethacarb, XMC and xylylcarb; dinitrophenol insecticides, such as dinex, dinoprop, dinosam and DNOC; fluorine insecticides, such as barium hexafluorosilicate, cryolite, sodium fluoride, sodium hexafluorosilicate and sulfluramid; formamidine insecticides, such as amitraz, chlordimeform, formetanate and formparanate; fumigant insecticides, such as acrylonitrile, carbon disulfide, carbon tetrachloride, chloroform, chloropicrin, para-dichlorobenzene, 1,2-dichloropropane, ethyl formate, ethylene dibromide, ethylene dichloride, ethylene oxide, hydrogen cyanide, iodomethane, methyl bromide, methylchloroform, methylene chloride, naphthalene, phosphine, sulfuryl fluoride and tetrachloroethane; inorganic insecticides, such as borax, calcium polysulfide, copper oleate, mercurous chloride, potassium thiocyanate and sodium thiocyanate; chitin synthesis inhibitors such as bistrifluron, buprofezin, chlorfluazuron, cyromazine, diflubenzuron, flucycloxuron, flufenoxuron, hexaflumuron, lufenuron, novaluron, noviflumuron, penfluron, teflubenzuron and triflumuron; juvenile hormone mimics, such as epofenonane, fenoxycarb, hydroprene, kinoprene, methoprene, pyriproxyfen and triprene; juvenile hormones such as juvenile hormone I, juvenile hormone II and juvenile hormone III; moulting hormone agonists, such as chromafenozide, halofenozide, methoxyfenozide and tebufenozide; moulting hormones such as α-ecdysone and ecdysterone; moulting inhibitors, such as diofenolan; precocenes, such as precocene I, precocene II and precocene III; unclassified insect growth regulators, such as dicyclanil; nereistoxin analogue insecticides, such as bensultap, cartap, thiocyclam and thiosultap; nicotinoid insecticides, such as flonicamid; nitroguanidine insecticides, such as clothianidin, dinotefuran, imidacloprid and thiamethoxam; aminofuranone neonicotinoids such as BYI-02960; semisynthetic fermentation products such as cypropen; nitromethylene insecticides, such as nitenpyram and nithiazine; pyridylmethylamine insecticides, such as acetamiprid, imidacloprid, nitenpyram and thiacloprid; organochlorine insecticides, such as bromo-DDT, camphechlor, DDT, pp′-DDT, ethyl-DDD, HCH, gamma-HCH, lindane, methoxychlor, pentachlorophenol and TDE; cyclodiene insecticides such as aldrin, bromocyclen, chlorbicyclen, chlordane, chlordecone, dieldrin, dilor, endosulfan, endrin, HEOD, heptachlor, HHDN, isobenzan, isodrin, kelevan and mirex; organophosphate insecticides, such as bromfenvinfos, chlorfenvinphos, crotoxyphos, dichlorvos, dicrotophos, dimethylvinphos, fospirate, heptenophos, methocrotophos, mevinphos, monocrotophos, naled, naftalofos, phosphamidon, propaphos, TEPP and tetrachlorvinphos; organothiophosphate insecticides, such as dioxabenzofos, fosmethilan and phenthoate; aliphatic organothiophosphate insecticides, such as acethion, amiton, cadusafos, chlorethoxyfos, chlormephos, demephion, demephion-O, demephion-S, demeton, demeton-O, demeton-S, demeton-methyl, demeton-O-methyl, demeton-S-methyl, demeton-S-methylsulphon, disulfoton, ethion, ethoprophos, IPSP, isothioate, malathion, methacrifos, oxydemeton-methyl, oxydeprofos, oxydisulfoton, phorate, sulfotep, terbufos and thiometon; aliphatic amide organothiophosphate insecticides, such as amidithion, cyanthoate, dimethoate, ethoate-methyl, formothion, mecarbam, omethoate, prothoate, sophamide and vamidothion; oxime organothiophosphate insecticides, such as chlorphoxim, phoxim and phoxim-methyl; heterocyclic organothiophosphate insecticides, such as azamethiphos, coumaphos, coumithoate, dioxathion, endothion, menazon, morphothion, phosalone, pyraclofos, pyridaphenthion and quinothion; benzothiopyran organothiophosphate insecticides, such as dithicrofos and thicrofos; benzotriazine organothiophosphate insecticides such as azinphos-ethyl and azinphos-methyl; isoindole organothiophosphate insecticides, such as dialifos and phosmet; isoxazole organothiophosphate insecticides, such as isoxathion and zolaprofos; pyrazolopyrimidine organothiophosphate insecticides, such as chlorprazophos and pyrazophos; pyridine organothiophosphate insecticides, such as chlorpyrifos and chlorpyrifos-methyl; pyrimidine organothiophosphate insecticides, such as butathiofos, diazinon, etrimfos, lirimfos, pirimiphos-ethyl, pirimiphos-methyl, primidophos, pyrimitate and tebupirimfos; quinoxaline organothiophosphate insecticides, such as quinalphos and quinalphos-methyl; thiadiazole organothiophosphate insecticides, such as athidathion, lythidathion, methidathion and prothidathion; triazole organothiophosphate insecticides, such as isazofos and triazophos; phenyl organothiophosphate insecticides, such as azothoate, bromophos, bromophos-ethyl, carbophenothion, chlorthiophos, cyanophos, cythioate, dicapthon, dichlofenthion, etaphos, famphur, fenchlorphos, fenitrothion fensulfothion, fenthion, fenthion-ethyl, heterophos, jodfenphos, mesulfenfos, parathion, parathion-methyl, phenkapton, phosnichlor, profenofos, prothiofos, sulprofos, temephos, trichlormetaphos-3 and trifenofos; phosphonate insecticides, such as butonate and trichlorfon; phosphonothioate insecticides, such as mecarphon; phenyl ethylphosphonothioate insecticides, such as fonofos and trichloronat; phenyl phenylphosphonothioate insecticides, such as cyanofenphos, EPN and leptophos; phosphoramidate insecticides such as crufomate, fenamiphos, fosthietan, mephosfolan, phosfolan and pirimetaphos; phosphoramidothioate insecticides such as acephate, isocarbophos, isofenphos, methamidophos and propetamphos; phosphorodiamide insecticides, such as dimefox, mazidox, mipafox and schradan; oxadiazine insecticides, such as indoxacarb; phthalimide insecticides, such as dialifos, phosmet and tetramethrin; pyrazole insecticides, such as acetoprole, ethiprole, fipronil, pyrafluprole, pyriprole, tebufenpyrad, tolfenpyrad and vaniliprole; pyrethroid ester insecticides, such as acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin and transfluthrin; pyrethroid ether insecticides, such as etofenprox, flufenprox, halfenprox, protrifenbute and silafluofen; pyrimidinamine insecticides, such as flufenerim and pyrimidifen; pyrrole insecticides, such as chlorfenapyr; tetronic acid insecticides, such as spirodiclofen, spiromesifen and spirotetramat; thiourea insecticides such as diafenthiuron; urea insecticides, such as flucofuron and sulcofuron; and unclassified insecticides, such as AKD-3088, closantel, crotamiton, cyflumetofen, EXD, fenazaflor, fenazaquin, fenoxacrim, fenpyroximate, FKI-1033, flubendiamide, cyazypyr (cyantraniliprole), hydramethylnon, isoprothiolane, malonoben, metaflumizone, metoxadiazone, nifluridide, NNI-9850, NNI-0101 (pyrifluquinazon), pymetrozine, pyridaben, pyridalyl, Qcide, rafoxanide, rynaxypyr (chlorantraniliprole), SYJ-159, triarathene, and triazamate, and any combinations thereof.

Some of the fungicides that can be employed beneficially in combination with the formulations of the present invention include: 2-(thiocyanatomethylthio)-benzothiazole, 2-phenylphenol, 8-hydroxyquinoline sulfate, Ampelomyces, quisqualis, azaconazole, azoxystrobin, Bacillus subtilis, benalaxyl, benomyl, benthiavalicarb-isopropyl, benzylaminobenzene-sulfonate (BABS) salt, bicarbonates, biphenyl, bismerthiazol, bitertanol, blasticidin-S, borax, Bordeaux mixture, boscalid, bromuconazole, bupirimate, calcium polysulfide, captafol, captan, carbendazim, carboxin, carpropamid, carvone, chloroneb, chlorothalonil, chlozolinate, Coniothyrium minitans, copper hydroxide, copper octanoate, copper oxychloride, copper sulfate, copper sulfate (tribasic), cuprous oxide, cyazofamid, cyflufenarnid, cymoxanil, cyproconazole, cyprodinil, dazomet, debacarb, diammonium ethylenebis-(dithiocarbamate), dichlofluanid, dichlorophen, diclocymet, diclomezine, dichloran, diethofencarb, difenoconazole, difenzoquat ion, diflumetorim, dimethomorph, dimoxystrobin, diniconazole, diniconazole-M, dinobuton, dinocap, diphenylamine, dithianon, dodemorph, dodemorph acetate, dodine, dodine free base, edifenphos, epoxiconazole, ethaboxam, ethoxyquin, etridiazole, famoxadone, fenamidone, fenarimol, fenbuconazole, fenfuram, fenhexamid, fenoxanil, fenpiclonil, fenpropidin, fenpropimorph, fentin, fentin acetate, fentin hydroxide, ferbam, ferimzone, fluazinam, fludioxonil, flumorph, fluopicolide, fluoroimide, fluoxastrobin, fluquinconazole, flusilazole, flusulfamide, flutolanil, flutriafol, folpet, formaldehyde, fosetyl, fosetyl-aluminium, fuberidazole, furalaxyl, furametpyr, guazatine, guazatine acetates, GY-81, hexachlorobenzene, hexaconazole, hymexazol, imazalil, imazalil sulfate, imibenconazole, iminoctadine, iminoctadine triacetate, iminoctadine tris(albesilate), ipconazole, iprobenfos, iprodione, iprovalicarb, isoprothiolane, kasugamycin, kasugamycin hydrochloride hydrate, kresoxim-methyl, mancopper, mancozeb, maneb, mepanipyrim, mepronil, mercuric chloride, mercuric oxide, mercurous chloride, metalaxyl, mefenoxam, metalaxyl-M, metam, metam-ammonium, metam-potassium, metam-sodium, metconazole, methasulfocarb, methyl iodide, methyl isothiocyanate, metiram, metominostrobin, metrafenone, mildiomycin, myclobutanil, nabam, nitrothal-isopropyl, nuarimol, octhilinone, ofurace, oleic acid (fatty acids), orysastrobin, oxadixyl, oxine-copper, oxpoconazole fumarate, oxycarboxin, pefurazoate, penconazole, pencycuron, pentachlorophenol, pentachlorophenyl laurate, penthiopyrad, phenylmercury acetate, phosphonic acid, phthalide, picoxystrobin, polyoxin B, polyoxins, polyoxorim, potassium bicarbonate, potassium hydroxyquinoline sulfate, probenazole, prochloraz, procymidone, propamocarb, propamocarb hydrochloride, propiconazole, propineb, proquinazid, prothioconazole, pyraclostrobin, pyrazophos, pyributicarb, pyrifenox, pyrimethanil, pyroquilon, quinoclamine, quinoxyfen, quintozene, Reynoutria sachalinensis extract, silthiofam, simeconazole, sodium 2-phenylphenoxide, sodium bicarbonate, sodium pentachlorophenoxide, spiroxamine, sulfur, SYP-Z071, tar oils, tebuconazole, tecnazene, tetraconazole, thiabendazole, thifluzamide, thiophanate-methyl, thiram, tiadinil, tolclofos-methyl, tolylfluanid, triadimefon, triadimenol, triazoxide, tricyclazole, tridemorph, trifloxystrobin, triflumizole, triforine, triticonazole, validamycin, vinclozolin, zineb, ziram, zoxamide, Candida oleophila, Fusarium oxysporum, Gliocladium spp., Phlebiopsis gigantean, Streptomyces griseoviridis, Trichoderma spp., (RS)—N-(3,5-dichlorophenyl)-2-(methoxymethyl)-succinimide, 1,2-dichloropropane, 1,3-dichloro-1,1,3,3-tetrafluoroacetone hydrate, 1-chloro-2,4-dinitronaphthalene, 1-chloro-2-nitropropane, 2-(2-heptadecyl-2-imidazolin-1-yl)ethanol, 2,3-dihydro-5-phenyl-1,4-dithi-ine 1,1,4,4-tetraoxide, 2-methoxyethylmercury acetate, 2-methoxyethylmercury chloride, 2-methoxyethylmercury silicate, 3-(4-chlorophenyl)-5-methylrhodanine, 4-(2-nitroprop-1-enyl)phenyl thiocyanateme: ampropylfos, anilazine, azithiram, barium polysulfide, Bayer 32394, benodanil, benquinox, bentaluron, benzamacril; benzamacril-isobutyl, benzamorf, binapacryl, bis(methylmercury)sulfate, bis(tributyltin)oxide, buthiobate, cadmium calcium copper zinc chromate sulfate, carbamorph, CECA, chlobenthiazone, chloraniformethan, chlorfenazole, chlorquinox, climbazole, copper bis(3-phenylsalicylate), copper zinc chromate, cufraneb, cupric hydrazinium sulfate, cuprobam, cyclafuramid, cypendazole, cyprofuram, decafentin, dichlone, dichlozoline, diclobutrazol, dimethirimol, dinocton, dinosulfon, dinoterbon, dipyrithione, ditalimfos, dodicin, drazoxolon, EBP, ESBP, etaconazole, etem, ethirim, fenaminosulf, fenapanil, fenitropan, fluotrimazole, furcarbanil, furconazole, furconazole-cis, furmecyclox, furophanate, glyodine, griseofulvin, halacrinate, Hercules 3944, hexylthiofos, ICIA0858, isopamphos, isovaledione, mebenil, mecarbinzid, metazoxolon, methfuroxam, methylmercury dicyandiamide, metsulfovax, milneb, mucochloric anhydride, myclozolin, N-3,5-dichlorophenyl-succinimide, N-3-nitrophenylitaconimide, natamycin, N-ethylmercurio-4-toluenesulfonanilide, nickel bis(dimethyldithiocarbamate), OCH, phenylmercury dimethyldithiocarbamate, phenylmercury nitrate, phosdiphen, prothiocarb; prothiocarb hydrochloride, pyracarbolid, pyridinitril, pyroxychlor, pyroxyfur, quinacetol; quinacetol sulfate, quinazamid, quinconazole, rabenzazole, salicylanilide, SSF-109, sultropen, tecoram, thiadifluor, thicyofen, thiochlorfenphim, thiophanate, thioquinox, tioxymid, triamiphos, triarimol, triazbutil, trichlamide, urbacid, XRD-563, and zarilamid, and any combinations thereof.

Some of the herbicides that can be employed in conjunction with the formulations of the present invention include: amide herbicides such as allidochlor, beflubutamid, benzadox, benzipram, bromobutide, cafenstrole, CDEA, chlorthiamid, cyprazole, dimethenamid, dimethenamid-P, diphenamid, epronaz, etnipromid, fentrazamide, flupoxam, fomesafen, halosafen, isocarbamid, isoxaben, napropamide, naptalam, pethoxamid, propyzamide, quinonamid and tebutam; anilide herbicides such as chloranocryl, cisanilide, clomeprop, cypromid, diflufenican, etobenzanid, fenasulam, flufenacet, flufenican, mefenacet, mefluidide, metamifop, monalide, naproanilide, pentanochlor, picolinafen and propanil; arylalanine herbicides, such as benzoylprop, flamprop and flamprop-M; chloroacetanilide herbicides, such as acetochlor, alachlor, butachlor, butenachlor, delachlor, diethatyl, dimethachlor, metazachlor, metolachlor, S-metolachlor, pretilachlor, propachlor, propisochlor, prynachlor, terbuchlor, thenylchlor and xylachlor; sulfonanilide herbicides, such as benzofluor, perfluidone, pyrimisulfan and profluazol; sulfonamide herbicides, such as asulam, carbasulam, fenasulam and oryzalin; antibiotic herbicides, such as bilanafos; benzoic acid herbicides, such as chloramben, dicamba, 2,3,6-TBA and tricamba; pyrimidinyloxybenzoic acid herbicides, such as bispyribac and pyriminobac; pyrimidinylthiobenzoic acid herbicides, such as pyrithiobac; phthalic acid herbicides, such as chlorthal; picolinic acid herbicides such as aminopyralid, clopyralid and picloram; quinolinecarboxylic acid herbicides, such as quinclorac and quinmerac; arsenical herbicides, such as cacodylic acid, CMA, DSMA, hexaflurate, MAA, MAMA, MSMA, potassium arsenite and sodium arsenite; benzoylcyclohexanedione herbicides, such as mesotrione, sulcotrione, tefuryltrione and tembotrione; benzofuranyl alkylsulfonate herbicides, such as benfuresate and ethofumesate; carbamate herbicides, such as asulam, carboxazole chlorprocarb, dichlormate, fenasulam, karbutilate and terbucarb; carbanilate herbicides, such as barban, BCPC, carbasulam, carbetamide, CEPC, chlorbufam, chlorpropham, CPPC, desmedipham, phenisopham, phenmedipham, phenmedipham-ethyl, propham and swep; cyclohexene oxime herbicides, such as alloxydim, butroxydim, clethodim, cloproxydim, cycloxydim, profoxydim, sethoxydim, tepraloxydim and tralkoxydim; cyclopropylisoxazole herbicides, such as isoxachlortole and isoxaflutole; dicarboximide herbicides, such as benzfendizone, cinidon-ethyl, flumezin, flumiclorac, flumioxazin and flumipropyn; dinitroaniline herbicides, such as benfluralin, butralin, dinitramine, ethalfluralin, fluchloralin, isopropalin, methalpropalin, nitralin, oryzalin, pendimethalin, prodiamine, profluralin and trifluralin; dinitrophenol herbicides, such as dinofenate, dinoprop, dinosam, dinoseb, dinoterb, DNOC, etinofen and medinoterb; diphenyl ether herbicides, such as ethoxyfen; nitrophenyl ether herbicides, such as acifluorfen, aclonifen, bifenox, chlomethoxyfen, chlornitrofen, etnipromid, fluorodifen, fluoroglycofen, fluoronitrofen, fomesafen, furyloxyfen, halosafen, lactofen, nitrofen, nitrofluorfen and oxyfluorfen; dithiocarbamate herbicides, such as dazomet and metam; halogenated aliphatic herbicides, such as alorac, chloropon, dalapon, flupropanate, hexachloroacetone, iodomethane, methyl bromide, monochloroacetic acid, SMA and TCA; imidazolinone herbicides, such as imazamethabenz, imazamox, imazapic, imazapyr, imazaquin and imazethapyr; inorganic herbicides, such as ammonium sulfamate, borax, calcium chlorate, copper sulfate, ferrous sulfate, potassium azide, potassium cyanate, sodium azide, sodium chlorate and sulfuric acid; nitrile herbicides, such as bromobonil, bromoxynil, chloroxynil, dichlobenil, iodobonil, ioxynil and pyraclonil; organophosphorus herbicides, such as amiprofos-methyl, anilofos, bensulide, bilanafos, butamifos, 2,4-DEP, DMPA, EBEP, fosamine, glufosinate, glyphosate and piperophos; phenoxy herbicides, such as bromofenoxim, clomeprop, 2,4-DEB, 2,4-DEP, difenopenten, disul, erbon, etnipromid, fenteracol and trifopsime; phenoxyacetic herbicides, such as 4-CPA, 2,4-D, 3,4-DA, MCPA, MCPA-thioethyl and 2,4,5-T; phenoxybutyric herbicides, such as 4-CPB, 2,4-DB, 3,4-DB, MCPB and 2,4,5-TB; phenoxypropionic herbicides, such as cloprop, 4-CPP, dichlorprop, dichlorprop-P, 3,4-DP, fenoprop, mecoprop and mecoprop-P; aryloxyphenoxypropionic herbicides, such as chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P and trifop; phenylenediamine herbicides, such as dinitramine and prodiamine; pyrazolyl herbicides, such as benzofenap, pyrazolynate, pyrasulfotole, pyrazoxyfen, pyroxasulfone and topramezone; pyrazolylphenyl herbicides, such as fluazolate and pyraflufen; pyridazine herbicides, such as credazine, pyridafol and pyridate; pyridazinone herbicides, such as brompyrazon, chloridazon, dimidazon, flufenpyr, metflurazon, norflurazon, oxapyrazon and pydanon; pyridine herbicides such as aminopyralid, cliodinate, clopyralid, dithiopyr, fluroxypyr, haloxydine, picloram, picolinafen, pyriclor, thiazopyr and triclopyr; pyrimidinediamine herbicides, such as iprymidam and tioclorim; quaternary ammonium herbicides, such as cyperquat, diethamquat, difenzoquat, diquat, morfamquat and paraquat; thiocarbamate herbicides, such as butylate, cycloate, di-allate, EPTC, esprocarb, ethiolate, isopolinate, methiobencarb, molinate, orbencarb, pebulate, prosulfocarb, pyributicarb, sulfallate, thiobencarb, tiocarbazil, tri-allate and vemolate; thiocarbonate herbicides, such as dimexano, EXD and proxan; thiourea herbicides such as methiuron; triazine herbicides, such as dipropetryn, triaziflam and trihydroxytriazine; chlorotriazine herbicides, such as atrazine, chlorazine, cyanazine, cyprazine, eglinazine, ipazine, mesoprazine, procyazine, proglinazine, propazine, sebuthylazine, simazine, terbuthylazine and trietazine; methoxytriazine herbicides, such as atraton, methometon, prometon, secbumeton, simeton and terbumeton; methylthiotriazine herbicides, such as ametryn, aziprotryne, cyanatryn, desmetryn, dimethametryn, methoprotryne, prometryn, simetryn and terbutryn; triazinone herbicides, such as ametridione, amibuzin, hexazinone, isomethiozin, metamitron and metribuzin; triazole herbicides, such as amitrole, cafenstrole, epronaz and flupoxam; triazolone herbicides, such as amicarbazone, bencarbazone, carfentrazone, flucarbazone, propoxycarbazone, sulfentrazone and thiencarbazone-methyl; triazolopyrimidine herbicides, such as cloransulam, diclosulam, florasulam, flumetsulam, metosulam, penoxsulam and pyroxsulam; uracil herbicides, such as butafenacil, bromacil, flupropacil, isocil, lenacil and terbacil; 3-phenyluracils; urea herbicides, such as benzthiazuron, cumyluron, cycluron, dichloralurea, diflufenzopyr, isonoruron, isouron, methabenzthiazuron, monisouron and noruron; phenylurea herbicides, such as anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluron, phenobenzuron, siduron, tetrafluron and thidiazuron; pyrimidinylsulfonylurea herbicides, such as amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, nicosulfuron, orthosulfamuron, oxasulfuron, primisulfuron, pyrazosulfuron, rimsulfuron, sulfometuron, sulfosulfuron and trifloxysulfuron; triazinylsulfonylurea herbicides, such as chlorsulfuron, cinosulfuron, ethametsulfuron, iodosulfuron, metsulfuron, prosulfuron, thifensulfuron, triasulfuron, tribenuron, triflusulfuron and tritosulfuron; thiadiazolylurea herbicides, such as buthiuron, ethidimuron, tebuthiuron, thiazafluron and thidiazuron; and unclassified herbicides such as acrolein, allyl alcohol, azafenidin, benazolin, bentazone, benzobicyclon, buthidazole, calcium cyanamide, cambendichlor, chlorfenac, chlorfenprop, chlorflurazole, chlorflurenol, cinmethylin, clomazone, CPMF, cresol, ortho-dichlorobenzene, dimepiperate, endothal, fluoromidine, fluridone, flurochloridone, flurtamone, fluthiacet, indanofan, methazole, methyl isothiocyanate, nipyraclofen, OCH, oxadiargyl, oxadiazon, oxaziclomefone, pentachlorophenol, pentoxazone, phenylmercury acetate, pinoxaden, prosulfalin, pyribenzoxim, pyriftalid, quinoclamine, rhodethanil, sulglycapin, thidiazimin, tridiphane, trimeturon, tripropindan, and tritac.

Other compounds and materials may be added provided they do not substantially interfere with the attractant activity of the composition of the invention. Whether or not an additive substantially interferes with the attractant activity can be determined by standard test formats including those that involve direct comparisons of the efficacy of the formulations of the present invention without at least one added compound and the composition of the present invention with at least one additional compound.

### EXPERIMENTS AND RESULTS

### 1. Preparation of Formulation A.

A pregel including about 1.5 wt % of Rilanit Plus® was made before assembling the formulation. The pregel was formed by adding Rilanit Plus® powder to a clean vessel with the designed amount of solvent (See Table 1), heating it to about 70° C., and holding it at that temperature for about 5 minutes. The formulation was completed by adding solvent (i.e., Exxsol D-130, Soybean oil and Aromatic 200ND), pregel, surfactants, and sulfoxaflor into a clean vessel under constant mixing. The mixture was then placed into a medium mill and ground for about 5 minutes using 1 mm glass beads. After milling, the formulation was packaged into a glass container for further evaluation.

### 2. Preparation of Formulation B.

A pregel including about 1.5 wt % of Rilanit Plus® was made before assembling the formulation. The pregel was formed by adding Rilanit Plus® powder to a clean vessel with the designed amount of solvent (See Table 1), heating it to about 70° C. and holding it at that temperature for about 5 minutes. The formulation was completed by adding solvent (i.e., Exxsol D-130, Soybean oil and Aromatic 200ND), pregel, surfactants, and sulfoxaflor into a clean vessel under constant mixing. The mixture was then placed into a medium mill and ground for about 5 minutes using 1 mm glass beads. After milling, the formulation was packaged into a glass container for further evaluation.

### 3. Preparation of Formulation C.

A pregel including about 1.5 wt % of Rilanit Plus® was made before assembling the formulation. The pregel was formed by adding Rilanit Plus® powder to a clean vessel with the designed amount of solvent (See Table 1), heating it to about 70° C. and holding it at that temperature for about 5 minutes. The formulation was completed by adding solvent (i.e., Exxsol D-130, Soybean oil and Aromatic 200ND), pregel, surfactants and sulfoxaflor into a clean vessel under constant mixing. The mixture was then placed into a medium mill and ground for about five minutes using 1 mm glass beads. After milling, the formulation was packaged into a glass container for further evaluation.

TABLE 1
Composition of Various Formulations that include
Sulfoxaflor as the active ingredient.

| | A. | B. | C. | D. |
|---|---|---|---|---|
| Ingredients | g/100 ml | g/100 ml | g/100 ml | g/100 ml |
| Sulfoxaflor | 24 | 24 | 24 | 24 |
| Rilanit Plus pregel | 46 | 25 | 50 | |
| (1.5%) | | | | |
| Exxsol D-130 | balance | | | |
| Agnique BL 4110 | 9 | | | |
| Eumulgin O 5 | 1 | | | |
| Soybean oil | | balance | | |
| Agnique BL 4130 | | 10 | | |
| Aromatic 200ND | | | balance | |
| Tensiofix N9824HF | | | 9 | 4 |
| Atlox 4912 | | | 1 | |
| Aerosil R974 | | | | 3.5 |
| Water | | | | 3 |
| Methylated soybean oil | | | | balance |
| Tensiofix N9811HF | | | | 12 |

TABLE 2
Chemical Names and/or Descriptions of the Components
Identified in Table 1 by Trade Name.

| Trade Name | Description - Source |
|---|---|
| Sulfoxaflor | Sulfoxaflor from Dow AgroSciences LLC |
| Rilanit Plus | Modified organic amide from Cognis Group, |
| | headquartered in Monheim, Germany |
| Exxsol D-130 | Hydrocarbon fluid from ExxonMobil Chemical |
| | Co., Baytown, TX |
| Agnique BL 4110 | Proprietary emulsifier blend from Cognis Group, |
| | headquartered in Monheim, Germany |
| Eumulgin O 5 | Ethoxylated Oleyl-Cetyl Alcohol from Cognis |
| | Group, headquartered in Monheim, Germany |
| Soybean oil | |
| Agnique BL 4130 | Proprietary emulsifier blend from Cognis Group, |
| | headquartered in Monheim, Germany |
| Aromatic 200ND | Naphthalene depleted heavy aromatic fluid from |
| | ExxonMobil Chemical Co., Baytown, TX |
| Tensiofix N9824HF | Proprietary emulsifier blend from S.A. Ajinomoto |
| | OmniChem N.V, headquartered in Mont-St-Guibert, |
| | Belgium |
| Atlox 4912 | Nonionic block copolymer from Croda Inc |
| | headquartered in Edison, NJ |
| Aerosil R974 | Hydrophobically modified fumed silica from Evonik |
| | Degussa GmbH, headquartered in Essen, Germany |
| Water | |
| Methylated | |
| soybean oil | |
| Tensiofix N9811HF | Proprietary emulsifier blend from S.A. Ajinomoto |
| | OmniChem N.V, headquartered in Mont-St-Guibert, |
| | Belgium |

### 4. Preparation of Formulation D.

The solvent methylated soybean oil was added into a clean vessel, next Aerosil R974 was added to vessel during a period of high shear mixing using a Silverson bench top batch homogenizer. After R974 was fully dispersed, the other ingredients (listed in Table 1) were added to the mixture in no particular order. The resulting mixture was homogenized for about five minutes to furnish the final formulation.

### 5. Standard (Std.) Formulation.

The standard formulation used as comparison in this invention was an aqueous suspension concentrate of sulfoxaflor with an active ingredient concentration of 240 g/L.

### 6. Treatment of Plants to Determine the Efficacy of Various Formulations.

Cotton plants were infested with whitefly eggs and plants with uniform infestation were selected for trial. Experimental formulations were diluted to the appropriate concentration in water and spray application was made when eggs hatched to become crawlers using a track sprayer calibrated to deliver 200 L/ha. Whitefly control from each treatment was determined by counting number of 4^{th} instar nymphs (red-eye) using a stereoscope. Experiments were carried out at two rates of a. i. (800 ppm and 200 ppm) for each formulation treatments with four replicate plants tested for each concentration.

Referring now to Table 3, results from testing these formulation on cotton plants (Table 3) demonstrate improved whitefly control from OD formulations D and A) at both concentrations (800 ppm and 200 ppm) over Std. formulation. Moderate level of control was obtained with Std. at 800 ppm (46%), but excellent control (92%) was obtained with formulation D and very good control was obtained with formulation A (78%).

TABLE 3
Results of Treating with Various Formulations

| | Treatment | | Desired | % |
|---|---|---|---|---|
| # | Name | % ai | ppm | Control |
| 1 | Std. | 22 | 800 | 46 |
| 2 | | | 200 | 30 |
| 3 | D. | 22 | 800 | 92 |
| 4 | | | 200 | 48 |
| 5 | A | 22 | 800 | 78 |
| 6 | | | 200 | 52 |
| 7 | Untreated | | | 0 |

The study was repeated. Referring now to Table 4 in the second study, as in the first study, better whitefly control was obtained by the addition of blank Oil Dispersed (OD), to Std. and from OD formulations (B, C, and A) than from treatment with only the Std. formulation. Whereas only 45% control was obtained with Std. at 800 ppm, enhanced whitefly control was obtained from addition of blank OD to 800 ppm Std. (66-89%) and from OD formulations at 800 ppm (70-72% control). Only marginal whitefly control was obtained from blank OD treatments. These results clearly indicate enhanced whitefly control from sulfoxaflor when formulated as an OD over an SC formulation.

TABLE 4
Results Obtained by Treating Plants with Various Formulations.

| | | Estimated | Percent |
|---|---|---|---|
| # | Treatment Name | PPM of a.i. | Control |
| 1 | Std. | 800 | 45 |
| 2 | Std. plus B (Blank) | 800 | 89 |
| 3 | | 200 | 67 |
| 4 | Std. plus C (Blank) | 800 | 66 |
| 5 | | 200 | 60 |
| 6 | Std. plus A (Blank) | 800 | 81 |
| 7 | | 200 | 59 |
| 8 | B | 800 | 72 |
| 9 | | 200 | 53 |
| 10 | C | 800 | 71 |
| 11 | | 200 | 51 |
| 12 | A | 800 | 70 |
| 13 | | 200 | 39 |
| 14 | B (Blank) | | 33 |
| 15 | | | 24 |
| 16 | C (Blank) | | 23 |
| 17 | | | 29 |
| 18 | A (Blank) | | 37 |
| 19 | | | 19 |
| 20 | Untreated | | 0 |

### 7. Field Trial of Plants Treated to Determine the Efficacy of Various Formulations.

Using standard foliar application equipment, various formulations of a sulfoxaflor insecticide were applied to plots of broccoli plants that were infested with Thrips tabaci (Thrips). At various intervals after treatment, five leaves were randomly collected from plants in each plot and placed into a solution of alcohol. The alcohol treated leaves were brought into the laboratory and the number of Thrips on each leaf was counted under a dissecting microscope. Each experiment was repeated four times.

The data collected in this study was transformed using Log(X+1) and analyzed using analysis of variance and the Student-Newman-Keuls test to compare the various treatments applied to the plants. Eight days after treatment, plants that were treated with the Standard formulation (Std.) did not have significant fewer Thrips than plants that were untreated, while plants treated with the formulations showed statistically significant fewer Thrips than the untreated plants.

Referring now to Table 5. Formulation D provided significantly better control of thrips 3 days after its application than did the Std. formulation. Formulation D also provided numerically better control 8 and 17 days after its application than did the Std. formulation.

TABLE 5
Results of Treating Broccoli Plants with Different
Formulation of sulfoximine Insecticides.

| | Application | No. of thrips per 5 leaves at | | |
|---|---|---|---|---|
| | rate | day after application* | | |
| Formulation | (g/ha) | Day 3 | Day 8 | Day 17 |
| Std. | 72 | 77 a | 83 ab | 95 a |
| D | 72 | 8 b | 23 a | 43 a |
| A | 72 | 50 ab | 60 a | 68 a |
| Untreated | — | 638 c | 357 b | 91 a |

*Mean followed by the same letter are not significantly different (P = 0.05, S-N-K).

While the novel technology has been illustrated and described in detail in the foregoing description, the same is to be considered as illustrative and not restrictive in character, it being understood that only the preferred embodiments have been shown and described and that all changes and modifications that come within the spirit of the novel technology are desired to be protected. As well, while the novel technology was illustrated using specific examples, theoretical arguments, accounts, and illustrations, these illustrations and the accompanying discussion should by no means be interpreted as limiting the technology. All patents, patent applications, and references to texts, scientific treatises, publications, and the like referenced in this application are incorporated herein by reference in their entirety.

We claim:

1. An insecticidal formulation, comprising:
a sulfoximine insecticide; and
a water-immiscible solvent wherein the sulfoximine is dispersed within said non-water-miscible solvent as particles, and the sulfoximine has insecticidal activity.

2. The formulation according to claim 1, wherein the sulfoximine is sulfoxaflor.

3. The formulation according to claim 1, wherein said water-immiscible solvent is selected from the group consisting of: methylated seed oils, light petroleum distillates, heavy petroleum distillates, seed oil, N-N-dimethyl alkyl amide, and mineral oils.

4. The formulation according to claim 1, wherein said water-immiscible solvent is methylated soybean oil.

5. The formulation according to claim 1, wherein said water-immiscible solvent is soybean oil.

6. The formulation according to claim 1, wherein said water-immiscible solvent is a hydrocarbon oil.

7. The formulation according to claim 1, wherein said water-immiscible solvent is a naphthalene depleted heavy aromatic solvent.

8. The formulation according to claim 3, further comprising an emulsifier.

9. The formulation according to claim 3, further comprising a second insecticide.

10. The formulation according to claim 3, further comprising at least one agriculturally active ingredient selected from the group consisting of fungicides, miticides, and herbicides.

11. A method of controlling an infestation of insects, comprising the steps of:
providing an oil dispersion, wherein said dispersion includes a sulfoximine insecticide particles dispersed within a water-immiscible solvent; and
contacting a surface adjacent to an insect with said oil dispersion.

12. The method according to claim 11, wherein the sulfoximine insecticide is sulfoxaflor.

13. The method according to claim 11, wherein said non-water-miscible solvent is selected from the group consisting of: methylated seed oils, light petroleum distillates, heavy petroleum distillates and mineral oils.

14. The method according to claim 11, wherein said non-water-miscible solvent is methylated soybean oil.

15. The method according to claim 11, wherein said non-water-miscible solvent is soybean oil.

16. The method according to claim 11, wherein said non-water-miscible solvent is a naphthalene depleted heavy aromatic.

17. The method according to claim 11, wherein the non-water-miscible solvent is a lipophilic hydrocarbon.

18. The method according to claim 11, further including an emulsifier.

19. The method according to claim 11, further including at least one agriculturally active ingredient selected from the group consisting of: a second insecticide, fungicides, miticides and herbicides.

20. An insecticidal formulation, comprising:
about 10% to about 50% by weight a sulfoximine insecticide;
soybean oil, wherein the sulfoximine insecticide is dispersed within said soybean oil as particles; and
a modified organic amide.
